(19) United States
(12) Patent Application Publication
(10) Pub. No.: US 2008/0281239 A1
(43) Pub. Date: Nov. 13, 2008

(54) Vibrating Device

(75) Inventor: Dirk Meile Marcel Tamminga, Haarlem (NL)

Correspondence Address: HOVEY WILLIAMS LLP, 10801 Mastin Blvd., Suite 1000, Overland Park, KS, 66210, US

(73) Assignee: Latam B.V., Haarlem (NL)

(21) Appl. No.: 12/095,889

(22) PCT Filed: Nov. 30, 2006
(86) PCT No.: PCT/NL06/00601

§ 371 Date: Jul. 21, 2008

(30) Foreign Application Priority Data
Dec. 1, 2005 (NL) 1030568

(51) Int. Cl. A61H 7/00

(52) U.S. Cl. 601/49

(57) ABSTRACT

The invention relates to a vibrating device intended to act on the human body, which vibrating device includes a baseplate, a support member extending upwards from the baseplate for the person who is using the device, a vibrating plate positioned above the baseplate, which is supported by resilient supports, and means for setting the vibrating plate vibrating in at least substantially vertical direction. The means for setting the vibrating plate vibrating in vertical direction includes a single electric motor which is rotatable about an at least substantially horizontal axis of rotation and which is provided with a weight which is arranged eccentrically with respect to said axis of rotation, which weight is to be rotated about said horizontal axis of rotation by the motor, wherein the electric motor and the weight connected to the electric motor are connected to the vibrating plate by means of a pivot pin which extends parallel to the axis of rotation of the electric motor and which is disposed above the electric motor, about which pivot pin the electric motor and the weight connected to the electric motor can freely pivot during operation.

The invention relates to a vibrating device intended to act on the human body, which vibrating device comprises a baseplate, a support member extending upwards from the baseplate for the person who is using the device, a vibrating plate positioned above the baseplate, which is supported by resilient supports, and means for setting the vibrating plate vibrating in at least substantially vertical direction.

Such vibrating devices are generally used for the purpose of acting on the human body in that a person somehow positions himself or herself on the vibrating plate in order to have the vibrations being generated act on his or her body.

With the usual vibrating devices of the above kind, two electric motors are used for setting the vibrating plate vibrating in vertical direction, each motor driving a weight that is arranged eccentrically with respect to the axis of rotation of the electric motor in question. To generate a vertical vibration, the two motors are set rotating in opposite directions, and care must be taken that the two weights driven by the motors reach their highest or lowest position simultaneously. Such gearing of the movement of the weights driven by the two motors is difficult to realise, whilst an incorrect gearing will lead to undesirable movements of the vibrating plate in a direction deviating from the vertical direction.

The object of the invention is to provide a vibrating device of the above kind in which the drawbacks of the known device can be avoided.

According to the invention, this object can be achieved in that the means for setting the vibrating plate vibrating in vertical direction are formed by a single electric motor which is rotatable about an at least substantially horizontal axis of rotation and which is provided with a weight which is arranged eccentrically with respect to said axis of rotation, which weight is to be rotated about said horizontal axis of rotation by the motor, wherein the electric motor and the weight connected to the electric motor are connected to the vibrating plate by means of a pivot pin which extends parallel to the axis of rotation of the electric motor and which is disposed above the electric motor, about which pivot pin the electric motor and the weight connected to the electric motor can freely pivot during operation.

Surprisingly it has been found that the vibrating plate can be set vibrating in vertical direction by using a single electric motor provided with an eccentrically arranged weight connected to the electric motor, which is pivot-mounted to the vibrating plate, without undesirable vibrations being generated in the vibrating plate in a direction deviating from the vertical direction.

As only a single electric motor provided with a weight driven thereby is needed, the problem of setting two electric motors provided with weights driven by said electric motors rotating in a precisely geared manner, which problem is frequently encountered in the known devices, no longer plays a role. Since furthermore only a single electric motor provided with a weight connected thereto is required for setting the vibrating plate vibrating in vertical direction, a significant saving in costs can furthermore be realised in comparison with the known devices.

The invention will be explained in more detail hereinafter in the description of an embodiment of a vibrating device according to the invention as schematically shown in the appended figures.

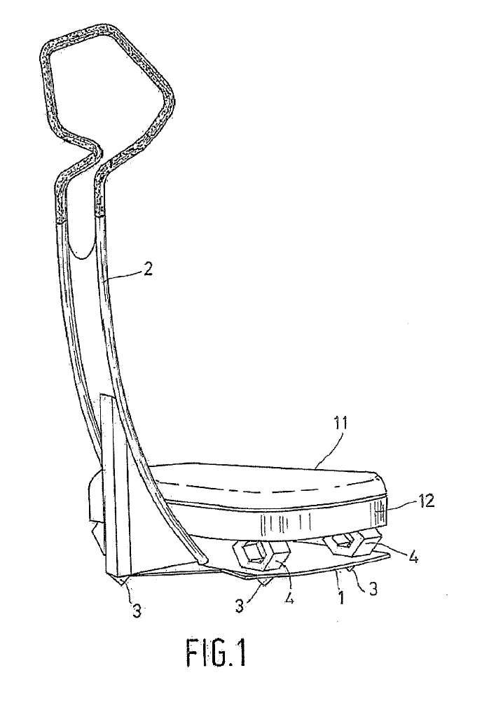

FIG. 1 is a perspective view of an embodiment of a vibrating device.

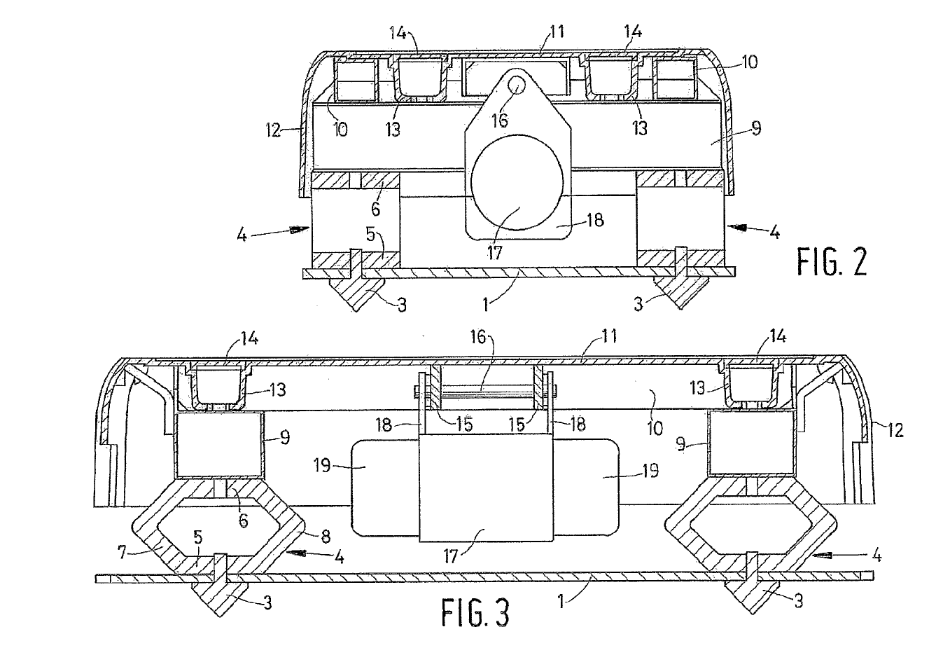

FIG. 2 is a cross-sectional view of a part of the vibrating device that is shown in FIG. 1.

FIG. 3 is a longitudinal sectional view of the part of the vibrating device that is shown in FIG. 2.

The vibrating device conventionally comprises a baseplate 1 and an elongated support member 2 that extends upwards from the baseplate 1.

The baseplate 1 and the support member 2 can be supported on the ground by means of supports 3 attached to the undersides of the baseplate 1 and the support member 2.

Four resilient supports 4 are attached to the baseplate, which supports are formed by elements made of a resilient material, such as rubber or an elastomeric material, in the illustrated embodiment, which elements are made up of two parts 5 and 6 arranged in parallel, spaced-apart relationship, the ends of which parts 5 and 6 are interconnected by V-shaped parts 7 and 8, respectively. As will be apparent from the figures, the parts 5 of the supports 4 abut against the upper side of the baseplate 1, whilst the parts 6 of the supports 4 that extent parallel to the parts 5 are attached to sections 9 being supported on said supports, all this in such a manner that each section 9 is supported by a resilient support 4 near both ends.

The two parallel sections 9 are connected by sections 10 supported on top of the sections 9, which sections 10 extend perpendicularly to the sections 9 and which are connected to the sections 9 near the ends.

Positioned above the sections 10 is a vibrating plate 11, which is disposed at least substantially horizontally during use of the device, which vibrating plate 11 is integral with a skirt 12 which joins the circumference of the vibrating plate and extends downwards therefrom. As will be apparent from the figures, the vibrating plate 11 and the skirt 12 joining said plate form some kind of cover, as it were, which encloses the space in which the aforesaid sections 9 and 10 are positioned.

The vibrating plate 11 is furthermore provided with cup-shaped parts 13, which extend downwards from the vibrating plate 11 and which are integral therewith.

Bolts (not shown) may be provided in said parts 13, by means of which bolts the vibrating plate can be fixed to the sections 9.

The cup-shaped parts can be closed at their upper ends by means of covers 14 lying substantially in one plane with the upper side of the vibrating plate.

As is apparent in particular from FIG. 3, two spaced-apart strip-shaped supports 15 are attached to the vibrating plate 11 near the centre of the vibrating plate, which supports support a horizontal pin 16 extending in the longitudinal direction of the vibrating plate. The central axis of the pin 16 lies in the vertical, longitudinal median plane of the vibrating plate 11. Two ears 18 supporting an electric motor 17 are freely pivotable about the ends of said pin 16. The arrangement is such that the axis of rotation of the electric motor 17 extends parallel to the pin 16, which extends horizontally during normal operation of the vibrating device.

Two weights (not shown), which are arranged eccentrically with respect to the axis of rotation of the motor 17, can be driven by means of the electric motors 17, which weights are accommodated in housings 19 which join the two ends of the electric motor 17 and which are disposed on either side of the vertical plane that extends through the centre of the vibrating plate 11, perpendicularly to the pin 16, being equally spaced therefrom

To use the above-described vibrating device, a person can support himself or herself entirely or partially on the vibrating plate in some usual manner, for example by positioning himself or herself in an upright or seated position on the vibrating plate, in which case the person in question may use the upwardly extending support member 2 for supporting one or more parts of his or her body.

By subsequently starting the motor 17, the weights driven by the motor, which are arranged eccentrically with respect to the axis of rotation of the motor, will transmit a vertical vibration to the vibrating plate via the ears 18, the pin 16 and the supports 15, and since the motor 17 and the weights driven thereby are pivot-mounted, at least substantially no forces will be transferred to the vibrating plate in a direction deviating from the vertical direction.

1. A vibrating device intended to act on a human body, said vibrating device comprising:
a baseplate;
a support member extending upwardly from the baseplate for the person who is using the device;
a vibrating plate positioned above the baseplate;
resilient supports for supporting the baseplate; and
means for setting the vibrating plate vibrating in at least a substantially vertical direction, wherein the means for setting the vibrating plate vibrating in a vertical direction are formed by a single electric motor which is rotatable about an at least substantially horizontal axis of rotation and which is provided with a weight which is operatively connected to the motor and arranged eccentrically with respect to the axis of rotation, which weight is to be rotated about said horizontal axis by rotation by the motor, wherein the electric motor and the weight connected to the electric motor are connected to the vibrating plate by means of a pivot pin which extends parallel to the axis of rotation of the electric motor and which is disposed above the electric motor, about which pivot pin the electric motor and the weight connected to the electric motor can freely pivot during operation.

2. A vibrating device according to claim 1, wherein the electric motor is connected to two weights disposed on either side of the electric motor, which weights are arranged eccentrically with respect to the axis of rotation of the motor.

3. A vibrating device according to claim 1, wherein the electric motor is freely pivotable about the pivot pin that is disposed above the electric motor.

4. A vibrating device according to claim 2, wherein the electric motor is freely pivotable about the pivot pin that is disposed above the electric motor.

5. A vibrating device intended to act on a human body, said device comprising:
a baseplate;
a support member extending upwardly from the baseplate for supporting a person using the device;
a vibrating plate positioned above the baseplate;
resilient supports connected to the baseplate for supporting the baseplate thereon;
a vibration actuating assembly for causing the vibrating plate to vibrate in a substantially vertical direction, said vibration actuating assembly consisting essentially of:
a single electric motor which is rotatable about a substantially horizontal axis of rotation;
a weight which is operatively connected to the motor and arranged eccentrically with respect to said axis of rotation, said weight being rotatable about said substantially horizontal axis of rotation by the single electric motor; and
a pivot pin connecting the electric motor and the weight to the pivot pin, said pivot pin extending parallel to the axis of rotation of the single electric motor and being disposed above the electric motor,
wherein the single electric motor and the weight are freely pivotable about the pin during operation.

6. A vibrating device according to claim 5, wherein the single electric motor is connected to two weights disposed on either side of the single electric motor, which weights are arranged eccentrically with respect to the axis of rotation of the motor.

7. A vibrating device according to claim 5, wherein the single electric motor is freely pivotable about the pivot pin that is disposed above the single electric motor.

8. A vibrating device according to claim 6, wherein the single electric motor is freely pivotable about the pivot pin that is disposed above the single electric motor.
